(19) United States
(12) Patent Application Publication
(10) Pub. No.: US 2019/0050317 A1
(43) Pub. Date: Feb. 14, 2019

(54) SYSTEMS AND METHODS FOR DETERMINING EVENT PROCESSING DELAYS

(71) Applicant: Google Inc., Mountain View, CA (US)

(72) Inventors: Navin Reginald Melville, Fremont, CA (US); Yuri Vasilevski, Mountain View, CA (US)

(73) Assignee: Google Inc., Mountain View, CA (US)

(21) Appl. No.: 14/043,548

(22) Filed: Oct. 1, 2013

(51) Int. Cl. G06F 11/34

(52) U.S. Cl. CPC G06F 11/3419

(57) ABSTRACT

Systems and methods for determining an event processing delay are provided. A described method includes receiving a log file including one or more non-processed events. Each event is associated with a data offset identifying a location in the log file. The method further includes identifying a plurality of statistical data points for the log file. Each of the statistical data points has a time value and a size value. The size value indicates a file size of the log file at a time corresponding to the time value. The method further includes determining an event time for an event by interpolating a new data point between the plurality of statistical data points. The new data point has a time value interpolated using the data offset associated with the event. The method further includes determining a processing delay by computing a difference between the event time and a current time.

### BACKGROUND

Event management systems are used to handle and process data elements known as “events.” Event data can be generated by various sources and often has at least one time-based attribute or dimension. For example, an event may be associated with a time at which the event occurred or the time the event was written to the log file. Events are typically stored in log files while awaiting processing by the event management system.

Time-based events often have a time-critical component associated with their processing. For example, events may include dimensions or attributes which are used as feedback for a system and can lead to an adjustment in the system via a feedback loop. However, the system cannot respond to the events until the events are processed. Thus, the duration of the delay in event processing may directly affect the system's ability to respond to external events. Monitoring the delay in processing of logged events can play a crucial role in determining a system's health and its ability to provide effective feedback.

When the number of events awaiting processing or undergoing processing is large, it is often difficult and expensive to obtain accurate delay metrics in real-time or near real time. Traditional systems resort to rough delay estimates that use surrogates for events (e.g., by “bundling” events so that there are less objects to track, using a creation time of a log file for all the events in the log file, etc.). However, the methods used by traditional systems are often inaccurate and fail to provide an effective measurement of the system's ability to provide a timely response to observed events.

### SUMMARY

One implementation of the present disclosure is a method for determining an event processing delay. The method includes receiving, at a computer system, a log file including one or more non-processed events. Each event of the one or more non-processed events may be associated with a data offset identifying a location of the event in the log file. The method further includes identifying, by the computer system, a plurality of statistical data points for the log file. Each of the statistical data points may include a time value and a size value, the size value indicating a file size of the log file at a time corresponding to the time value. The method further includes determining, by the computer system, an event time for an event of the one or more non-processed events. Determining the event time may include interpolating a new data point between the plurality of statistical data points for the log file. The new data point may have an interpolated time value. The interpolated time value may be interpolated using the data offset associated with the event. The method further includes determining, by the computer system, a processing delay associated with the event. The event processing delay may be determined by computing a difference between the event time and a current time.

In some implementations, the method further includes determining an event processing delay for one or more additional non-processed events, computing an average event processing delay by averaging the event processing delays for the event and the one or more additional non-processed events, and reporting the average event processing delay.

In some implementations, the data offset associated with the event is a data offset for a block of non-processed bytes in the log file. The block of non-processed bytes may include one or more of the non-processed events. The data offset for the block of non-processed bytes may be the data offset associated with each of the one or more non-processed events in the block of non-processed bytes.

In some implementations, the method further includes identifying a block of non-processed bytes in the log file. The block of non-processed bytes may have a starting data offset and an ending data offset and may include one or more of the non-processed events. The method may further include identifying multiple discrete portions of the log file. The multiple discrete portions may be delimited by the plurality of statistical data points. The method may further include determining whether the block of non-processed bytes spans multiple discrete portions of the log file. It may be determined that the block of non-processed bytes spans multiple discrete portions of the log file if the size value of one or more of the statistical data points is between the starting data offset and the ending data offset. Determining the event time for an event in a block of non-processed bytes which spans multiple discrete portions of the log file may be performed differently than determining the event time for an event in a block of non-processed bytes which does not span multiple discrete portions of the log file.

In some implementations, the method further includes, prior to determining the event time for the event, determining whether the event is in a block of non-processed bytes which spans multiple discrete portions of the log file or whether the event is in a block of non-processed bytes which does not span multiple discrete portions of the log file. If the event is in a block of non-processed bytes which does not span multiple discrete portions of the log file, determining the event time for the event may include identifying the interpolated time value as the event time.

If the event is in a block of non-processed bytes which spans multiple discrete portions of the log file, determining the event time for the event may include dividing the block of non-processed bytes into multiple sub-blocks determining a sub-event time for each of the multiple sub-blocks, and determining the event time by computing a weighted average of the multiple sub-event times.

In some implementations, dividing the block of non-processed bytes into multiple sub-blocks includes identifying one or more of the plurality of statistical data points having a size value between a starting data offset of the block of non-processed bytes and an ending data offset of the block of non-processed bytes, using the starting data offset of the block of non-processed bytes as a data offset for a first sub-block of the multiple sub-blocks, and using the one or more size values of the identified statistical data points as data offsets for one or more additional sub-blocks of the multiple sub-blocks.

In some implementations, determining a sub-event time for each of the multiple sub-blocks includes identifying one or more of the plurality of statistical data points having a size value between a starting data offset of the block of non-processed bytes and an ending data offset of the block of non-processed bytes, using the interpolated time value as the sub-event time for a first of the multiple sub-blocks, and using the one or more time values of the identified statistical data points as the sub-event times for one or more additional sub-blocks of the multiple sub-blocks. The starting data offset for the block of non-processed bytes is the data offset associated with the event may be used for interpolating the interpolated time value.

In some implementations, computing the weighted average of the multiple sub-event times includes identifying a data size for each of the multiple sub-blocks, determining a weight for each of the multiple sub-blocks by dividing the data size of the sub-block by a data size of the block of non-processed bytes, and computing the weighted average by multiplying, for each of the multiple sub-blocks, the weight for the sub-block by the sub-event time for the sub block and summing the resultant products.

In some implementations, the plurality of statistical data points include a first data point having a first time value and a first size value and a second data point having a second time value and a second size value. The data offset associated with the event may be greater than or equal to the first size value and less than or equal to the second size value. In some implementations, determining the event time includes identifying a data offset proportion by dividing a first difference between the data offset associated with the event and the first size value by a second difference between the second size value and the first size value, identifying a time value proportion by multiplying the data offset proportion by a difference between the second time value and the first time value, and determining the event time by adding the time value proportion to the first time value.

In some implementations, the event time is determined without reading event data from the log file. In some implementations, the log file does not include timestamps associated with the one or more non-processed events.

In some implementations, the method further includes collecting the plurality of statistical data points for the log file. Collecting the plurality of statistical data points may include observing a first file size of the log file at a first time and recording a first statistical data point. The first file size may be the size value of the first statistical data point and the first time may be the time value of the first statistical data point. Collecting the plurality of statistical data points may further include repeating the observing and recording steps until a plurality of statistical data points are collected. In some implementations, the method further includes controlling an accuracy of the event time determination by adjusting a rate at which the plurality of statistical data points are collected.

In some implementations, the method further includes selecting one or more of the plurality of statistical data points for removal from the plurality of statistical data points. Selecting one or more of the plurality of statistical data points for removal may include identifying the time values associated with the plurality of statistical data points, determining a subset of the plurality of statistical data points for which a uniformity of distribution of the time values associated with the plurality of statistical data points in the subset is maximized, and selecting for removal one or more of the plurality of statistical data points not in the subset.

Another implementation of the present disclosure is a system for determining event processing delays. The system includes a communications interface configured to receive a log file including one or more non-processed events. Each event of the one or more non-processed events may be associated with a data offset identifying a location of the event in the log file. The system further includes a processing circuit configured to identify a plurality of statistical data points for the log file. Each of the statistical data points may include a time value and a size value, the size value indicating a file size of the log file at a time corresponding to the time value. The processing circuit is further configured to determine an event time for an event of the one or more non-processed events. Determining the event time may include interpolating a new data point between the plurality of statistical data points for the log file, the new data point having an interpolated time value. The interpolated time value may be interpolated using the data offset associated with the event. The processing circuit is further configured to determine a processing delay associated with the event, wherein the processing delay is determined by computing a difference between the event time and a current time.

In some implementations, the processing circuit is further configured to determine an event processing delay for one or more additional non-processed events, compute an average event processing delay by averaging the event processing delays for the event and the one or more additional non-processed events, and report the average event processing delay.

In some implementations, the data offset associated with the event is a data offset for a block of non-processed bytes in the log file. The block of non-processed bytes may include one or more of the non-processed events. The data offset for the block of non-processed bytes may be the data offset associated with each of the one or more non-processed events in the block of non-processed bytes.

In some implementations, the processing circuit is further configured to identify a block of non-processed bytes in the log file. The block of non-processed bytes may have a starting data offset and an ending data offset and may include one or more of the non-processed events. The processing circuit may further be configured to identify multiple discrete portions of the log file and determine whether the block of non-processed bytes spans multiple discrete portions of the log file. The multiple discrete portions may be delimited by the plurality of statistical data points. The block of non-processed bytes may span multiple discrete portions of the log file if the size value of one or more of the statistical data points is between the starting data offset and the ending data offset. Determining the event time for an event in a block of non-processed bytes which spans multiple discrete portions of the log file may be performed differently than determining the event time for an event in a block of non-processed bytes which does not span multiple discrete portions of the log file.

In some implementations, the processing circuit is further configured to, prior to determining the event time for the event, determine whether the event is in a block of non-processed bytes which spans multiple discrete portions of the log file or whether the event is in a block of non-processed bytes which does not span multiple discrete portions of the log file. If the event is in a block of non-processed bytes which does not span multiple discrete portions of the log file, determining the event time for the event may include identifying the interpolated time value as the event time.

In some implementations, if the event is in a block of non-processed bytes which spans multiple discrete portions of the log file, determining the event time for the event includes dividing the block of non-processed bytes into multiple sub-blocks, determining a sub-event time for each of the multiple sub-blocks, and determining the event time by computing a weighted average of the multiple sub-event times.

In some implementations, dividing the block of non-processed bytes into multiple sub-blocks includes identifying one or more of the plurality of statistical data points having a size value between a starting data offset of the block of non-processed bytes and an ending data offset of the block of non-processed bytes, using the starting data offset of the block of non-processed bytes as a data offset for a first sub-block of the multiple sub-blocks, and using the one or more size values of the identified statistical data points as data offsets for one or more additional sub-blocks of the multiple sub-blocks.

In some implementations, determining a sub-event time for each of the multiple sub-blocks includes identifying one or more of the plurality of statistical data points having a size value between a starting data offset of the block of non-processed bytes and an ending data offset of the block of non-processed bytes, using the interpolated time value as the sub-event time for a first of the multiple sub-blocks, and using the one or more time values of the identified statistical data points as the sub-event times for one or more additional sub-blocks of the multiple sub-blocks. The starting data offset for the block of non-processed bytes may be the data offset associated with the event used for interpolating the interpolated time value.

In some implementations, computing the weighted average of the multiple sub-event times includes identifying a data size for each of the multiple sub-blocks and determining a weight for each of the multiple sub-blocks. The weight for a sub-block may be determined by dividing the data size of the sub-block by a data size of the block of non-processed bytes. Computing the weighted average of the multiple sub-event times may further include computing the weighted average by multiplying, for each of the multiple sub-blocks, the weight for the sub-block by the sub-event time for the sub block and summing the resultant products.

In some implementations, the plurality of statistical data points include a first data point having a first time value and a first size value and a second data point having a second time value and a second size value. The data offset associated with the event may be greater than or equal to the first size value and less than or equal to the second size value. In some implementations, determining the event time includes identifying a data offset proportion by dividing a first difference between the data offset associated with the event and the first size value by a second difference between the second size value and the first size value, identifying a time value proportion by multiplying the data offset proportion by a difference between the second time value and the first time value, and determining the event time by adding the time value proportion to the first time value.

In some implementations, the processing circuit is configured to determine the event time without reading event data from the log file. In some implementations, the log file does not include timestamps associated with the one or more non-processed events.

In some implementations, the processing circuit is further configured collect the plurality of statistical data points for the log file. Collecting the plurality of statistical data points may include observing a first file size of the log file at a first time and recording a first statistical data point. The first file size may be the size value of the first statistical data point and the first time may be the time value of the first statistical data point. Collecting the plurality of statistical data points may further include repeating the observing and recording steps until a plurality of statistical data points are collected.

In some implementations, the processing circuit is further configured to control an accuracy of the event time determination by adjusting a rate at which the plurality of statistical data points are collected.

### BRIEF DESCRIPTION OF THE DRAWINGS

FIG. 1 is a drawing of a computer system including an event logging/processing system configured determine an event processing delay associated with events currently awaiting or undergoing processing, shown according to a described implementation.

FIG. 2 is a drawing of a flow diagram illustrating how the event logging/processing system handles received events, shown according to a described implementation.

FIG. 3 is a drawing of a processing pipeline through which received events are processed by the event logging/processing system, shown according to a described implementation.

FIG. 4 is a block diagram illustrating the event logging/processing system in greater detail, shown according to a described implementation.

FIG. 5 is a drawing of a log file illustrating an increase in the data size of the log file over time and showing a plurality of statistical data points indicating the file size of the log at file at a plurality of observation times, shown according to a described implementation.

FIG. 6 is a drawing of the log file of FIG. 5 with alternating blocks of bytes marked as either processed bytes or non-processed bytes, shown according to a described implementation.

FIG. 7 is a drawing of a portion of the log file of FIG. 6, showing a block of non-processed bytes which does not span multiple discrete portions of the log file, shown according to a described implementation.

FIG. 8 is a drawing of a portion of the log file of FIG. 6, showing a block of non-processed bytes which spans two discrete portions of the log file, shown according to a described implementation.

FIG. 9 is a drawing of a portion of the log file of FIG. 6, showing a block of non-processed bytes which spans three or more discrete portions of the log file, shown according to a described implementation.

FIG. 10 is a histogram of event processing delay times which may be used to identify a delay time for a particular percentage of non-processed bytes, according to a described implementation.

FIG. 11 is a flowchart of a process for determining event processing delays, according to a described implementation.

### DETAILED DESCRIPTION

Referring generally to the FIGURES, systems and methods for determining event processing delays are shown, according to a described implementation. In general, an event may be a data element representing an occurrence, an action, a measurement, or other receipt of data. For example, in a computer environment (e.g., a local network, the Internet, etc.) an event may be generated by a computing device upon detecting that a particular action has been performed (e.g., clicking on a link, viewing an online resource, submitting a search request, requesting a content item, etc.). Events may be generated in response to a wide variety of occurrences and/or incidents (e.g., an alarm, an alert, receipt of network data, an email, a notification, a transaction, a server restart, etc.) and may be triggered by manual or automated actions.

Events may be communicated to an event logging/processing system and may be stored in log files while awaiting processing. Events may include at least one time-based attribute or dimension. The time-based attribute or dimension may indicate a time at which the event occurred, a time at which the event is received by the logging/processing system, or another time metric associated with the occurrence, logging, or processing of the event. The systems and methods described herein may be used to accurately determine a delay associated with the processing of logged events.

In some implementations, the event processing delay for a particular event is defined as the difference between a current time (e.g., “now”) and a time the event entered a “processing pipeline.” An event may enter the processing pipeline when the event is written to a log file and may exit the processing pipeline when processing of the event is completed (e.g., when the event data is extracted, written to a results cluster, etc.). Thus, the event processing delay for an event currently in the processing pipeline may describe an elapsed time since the event was written to a log file. In some implementations, event processing delay may be an average of the event processing delays for all events currently in the processing pipeline.

In some implementations, the term “event processing delay” applies to events which are currently in the processing pipeline (e.g., events which have not yet been processed or have not completed processing). Once event processing is completed, the event processing delay may be replaced with the processing latency. The processing latency for a particular event may be defined as the time required for an event to pass entirely through the processing pipeline. The term “processing latency” may apply to events which have exited the processing pipeline upon completing processing.

The systems and methods described herein may be used to determine not only processing latency, but also the processing delay for events currently in the processing pipeline. Since the processing delay applies to the events currently in the processing pipeline, the event processing delay indicates the current rate at which events are being processed and may be used to monitor the health of the event/log processing system.

In some implementations, the time at which an event enters the processing pipeline (e.g., the time at which the event is written to the log file) is defined as the “event time.” Event processing delay may be calculated by subtracting the event time from the current time. In some implementations, the systems and methods of the present disclosure may determine an event time without reading the event data or the log file. For example, event time may be determined without reading the time-based dimensions or attributes of the events and without reading a time at which the events were written to the log file. In fact, using the systems and methods described herein, it may be unnecessary to record a timestamp for received events.

The event time for a particular event may be determined by interpolating between statistical data points associated with the log file in which the events are stored. For example, the data size of the log file may be observed at various times as events are written therein. Each of the statistical data points may include a size value indicating a data size of the log file and a time value indicating a time at which the size value was observed. Byte offsets in the log file may be used as surrogates for events. For example, at time t₁, a log file may be observed as having a size s₁. At time t₂, the log file may be observed as having a size s₂. From this information, it can be determined that an event having a byte offset between s₁ and s₂ occurred at some time between t₁ and t₂. Interpolation between data points may be used to determine an estimated event time. The accuracy of the interpolation can be controlled by adjusting the frequency with which log file statistics are observed.

Other aspects, inventive features, and advantages of the systems and methods described herein will become apparent in the detailed description set forth below taken in conjunction with the accompanying drawings.

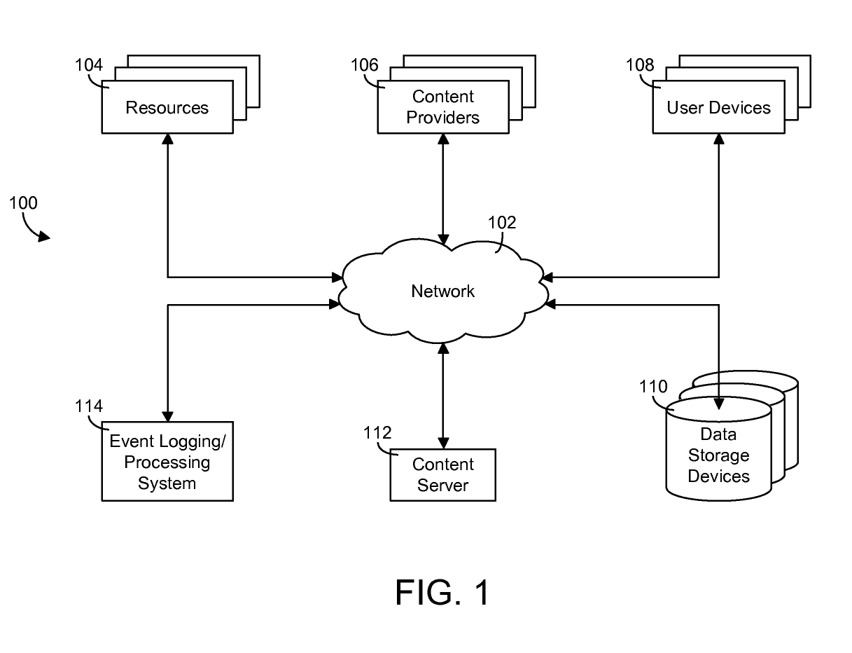

Referring now to FIG. 1, a block diagram of a computer system 100 is shown, according to a described implementation. In brief overview, computer system 100 is shown to include a network 102, resources 104, content providers 106, user devices 108, data storage devices 110, a content server 112, and an event logging/processing system 114. Computer system 100 may facilitate communication between resources 104, content providers 106, user devices 108, and event logging/processing system 114. For example, user devices 108 may request and receive resource content (e.g., web pages, documents, etc.) from resources 104 via network 102. Event logging/processing system 114 may receive an event from resources 104 and/or user devices 108 when a resource is viewed or otherwise provided to user devices 108 (e.g., a pageview event, a conversion event, etc.). In some implementations, resources 104 may include content item slots for presenting third-party content items from content providers 106. Event logging/processing system 114 may receive an event from content providers 106 and/or user devices 108 when a content item is distributed or presented (e.g., an impression event) or upon a user interaction with a distributed content item (e.g., a click event, a hover event, etc.).

Still referring to FIG. 1, and in greater detail, computer system 100 is shown to include a network 102. Network 102 may be a local area network (LAN), a wide area network (WAN), a cellular network, a satellite network, a radio network, the Internet, or any other type of data network or combination thereof. Network 102 may include any number of computing devices (e.g., computers, servers, routers, network switches, etc.) configured to transmit, receive, or relay data. Network 102 may further include any number of hardwired and/or wireless connections. For example, user devices 108 may communicate wirelessly (e.g., via WiFi, cellular, radio, etc.) with a transceiver that is hardwired (e.g., via a fiber optic cable, a CAT5 cable, etc.) to a computing device of network 102.

Still referring to FIG. 1, computer system 100 is shown to include resources 104. Resources 104 may include any type of information or data structure that can be provided over network 102. In some implementations, resources 104 may be identified by a resource address associated with each resource (e.g., a uniform resource locator (URL)). Resources 104 may include web pages (e.g., HTML web pages, PHP web pages, etc.), word processing documents, portable document format (PDF) documents, images, video, programming elements, interactive content, streaming video/audio sources, or other types of electronic information. Resources 104 may include content (e.g., words, phrases, images, sounds, etc.) having embedded information (e.g., meta-information embedded in hyperlinks) and/or embedded instructions. Embedded instructions may include computer-readable instructions (e.g., software code, JavaScript®, ECMAScript®, etc.) which are executed by user devices 108 (e.g., by a web browser running on user devices 108).

In some implementations, resources 104 may include content slots for presenting third-party content items. For example, resources 104 may include one or more inline frame elements (e.g., HTML “iframe” elements, <iframe> . . . </iframe>) for presenting third-party content items from content providers 106. An inline frame can be the “target” frame for links defined by other elements and can be selected by user agents (e.g., user devices 108, a web browser running on user devices 108, etc.) as the focus for printing, viewing its source, or other forms of user interaction. The content slots may cause user devices 108 to request third-party content items in response to viewing first-party resource content from resources 104.

Resources 104 may generate a variety of events. For example, in some implementations, resources 104 generate events when resource content is viewed, requested, presented, accessed, or in response to any other type of action or occurrence with respect to resource content (e.g., pageview events). Resources 104 may generate events associated with third party content items presented via resources 104 (e.g., impression events, click events, etc.). In some implementations, resources 104 generate conversion events in response to an action or behavior (e.g., by user devices 108) which satisfies conversion criteria (e.g., online purchases, click-through paths, etc.). Resources 104 may communicate events to event logging processing system 114 via network 102.

Still referring to FIG. 1, computer system 100 is shown to include content providers 106. Content providers 106 may include one or more electronic devices representing advertisers, resource operators, business owners, or other entities capable of producing content associated with an event received by event logging/processing system 114. In some implementations, content providers 106 produce content items (e.g., an ad creative) for presentation to user devices 108. In other implementations, content providers 106 may submit a request to have content items automatically generated. The content items may be stored in one or more data storage devices local to content providers 106, within content server 112, or in data storage devices 110.

In some implementations, the content items may be advertisements. The advertisements may be display advertisements such as image advertisements, Flash® advertisements, video advertisements, text-based advertisements, or any combination thereof. In other implementations, the content items may include other types of content which serve various non-advertising purposes. The content items may be displayed in a content slot of resources 104 and presented (e.g., alongside other resource content) to user devices 108.

In some implementations, content providers 106 may submit campaign parameters to content server 112. The campaign parameters may be used to control the distribution of content items to user devices 108. The campaign parameters may include keywords associated with the content items, bids corresponding to the keywords, a content distribution budget, geographic limiters, or other criteria used by content server 112 to determine when a content item may be presented to user devices 108.

Content providers 106 may access content server 112 to monitor the performance of the content items distributed according to the established campaign parameters. For example, content providers 106 may access content server 112 and/or event logging/processing system 114 to review one or more behavior metrics associated with a content item or set of content items. The behavior metrics may describe the interactions between user devices 108 with respect to a distributed content item or set of content items (e.g., number of impressions, number of clicks, number of conversions, an amount spent, etc.). The behavior metrics may be based on events logged and processed by event logging/processing system 114.

Still referring to FIG. 1, computer system 100 is shown to include user devices 108. User devices 108 may include any number and/or type of user-operable electronic devices. For example, user devices 108 may include desktop computers, laptop computers, smartphones, tablets, mobile communication devices, remote workstations, client terminals, entertainment consoles, or any other devices capable of interacting with the other components of computer system 100 (e.g., via a communications interface). For example, user devices 108 may be capable of receiving resource content from resources 104 and/or third-party content items from content providers 106 or content server 112. User devices 108 may include mobile devices or non-mobile devices.

In some implementations, user devices 108 include an application (e.g., a web browser, a resource renderer, etc.) for converting electronic content into a user-comprehensible format (e.g., visual, aural, graphical, etc.). User devices 108 may include a user interface element (e.g., an electronic display, a speaker, a keyboard, a mouse, a microphone, a printer, etc.) for presenting content to a user, receiving user input, or facilitating user interaction with electronic content (e.g., clicking on a content item, hovering over a content item, etc.). User devices 108 may function as a user agent for allowing a user to view HTML encoded content. User devices 108 may include a processor capable of processing embedded information (e.g., meta information embedded in hyperlinks, etc.) and executing embedded instructions. Embedded instructions may include computer-readable instructions (e.g., software code, JavaScript®, ECMAScript®, etc.) associated with a content slot within which a third-party content item is presented.

In some implementations, user devices 108 may be capable of detecting an interaction with a distributed content item. An interaction with a content item may include displaying the content item, hovering over the content item, clicking on the content item, viewing source information for the content item, or any other type of interaction between user devices 108 and a content item. Interaction with a content item does not require explicit action by a user with respect to a particular content item. In some implementations, an impression (e.g., displaying or presenting the content item) may qualify as an interaction. The criteria for defining which user actions (e.g., active or passive) qualify as an interaction may be determined on an individual basis (e.g., for each content item), by content providers 106, or by content server 112.

User devices 108 may generate a variety of events. For example, user devices 108 may generate events in response to a detected interaction with a content item. The event may include a plurality of attributes including a content identifier (e.g., a content ID or signature element), a device identifier, a referring URL identifier, an event timestamp, or any other attributes describing the interaction. User devices 108 may generate events when particular actions are performed by a user device (e.g., resource views, online purchases, search queries submitted, etc.). The events generated by user devices 108 may be communicated to event logging/processing system 114 via network 102.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated (e.g., by content server 114) in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by user devices 108, etc.) and used by content server 114.

Still referring to FIG. 1, computer system 100 is shown to include data storage devices 110. Data storage devices 110 may be any type of memory device capable of storing profile data, content item data, accounting data, or any other type of data used by event logging/processing system 114. Data storage devices 110 may include any type of non volatile memory, media, or memory devices. For example, data storage devices 110 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks. In some implementations, data storage devices 110 may be local to content server 112, event logging/processing system 114, or content providers 106. In other implementations, data storage devices 110 may be remote data storage devices connected with event logging/processing system 112 and/or content server 114 via network 102. In some implementations, data storage devices 110 may be part of a data storage server or system capable of receiving and responding to queries from content server 112.

In some implementations, data storage devices 110 store events in log files. For example, events received at event logging/processing system 114 may be written to log files and stored in data storage devices 110. The log files may include log metadata, non-processed events, processed events, clustered or bundled events, or any combination thereof. In some embodiments, data storage devices 110 store log statistics associated with the log files. For example, the log statistics may include a plurality of statistical data points describing the log files. Each of the statistical data points may include a size value indicating a data size of the log file and a time value indicating a time at which the corresponding size value was observed. The log statistics may be stored with the log files (e.g., as metadata) or separately from the log files.

Still referring to FIG. 1, computer system 100 is shown to include a content server 112. Content server 112 may receive a request for a content item from resources 104 and/or user devices 108. In some implementations, the request for content items may include characteristics of one or more content slots in which the content items will be displayed. For example, such characteristics may include the URL of the resource 104 in which the content slot is located, a display size of the content slot, a position of the content slot, and/or media types that are available for presentation in the content slot. If the content slot is located on a search results page, keywords associated with the search query may also be provided to content server 112. The characteristics of the content slot and/or keywords associated with the content request may facilitate identification of content items that are relevant to resources 104 and/or to the search query.

Content server 112 may select an eligible content item in response to the request received from resources 104 or user devices 108. In some implementations, eligible content items may include content items having characteristics matching the characteristics of the content slots in which the content items are to be presented. For example, content server 112 may select a content item having a display size which fits in a destination content slot. In some implementations, content server 112 may resize a selected content item to fit a content slot or add additional visual content to the selected content item (e.g., padding, a border, etc.) based on the display size of the content item and the display size of the content slot.

In some implementations, content server 112 may select a content item determined to be relevant to particular resource 104, user device 108, or search query. For example, content server 112 may select a content item by comparing the keywords associated with each content item (e.g., specified by content providers 106, additional keywords extracted from the content item, etc.) with the keywords associated with the resource 104 or user device 108 requesting the content item. A topic or type of content included in resources 104 may be used to establish keywords for resources 104.

In some implementations, content server 112 may select a content item by comparing the keywords associated with each content item with information (e.g., profile data, user preferences, etc.) associated with a particular user device 108 requesting the content item. In some implementations, content server 112 may select a content item that does not match established user preferences if an insufficient number of preferred content items are available. In some implementations, content server 112 may select a content item based on an established click-through-rate, a predicted click-through-rate, a bid price associated with each content item, or other relevant selection criteria.

Content server 112 may generate a variety of events. For example, content server 112 may generate events in response to receiving a request for a content item, selecting an eligible content item, and/or delivering the content item to user devices 108. The events generated by content server 112 may relate to the distribution and selection of content items and may be communicated to event logging/processing system 114 via network 102.

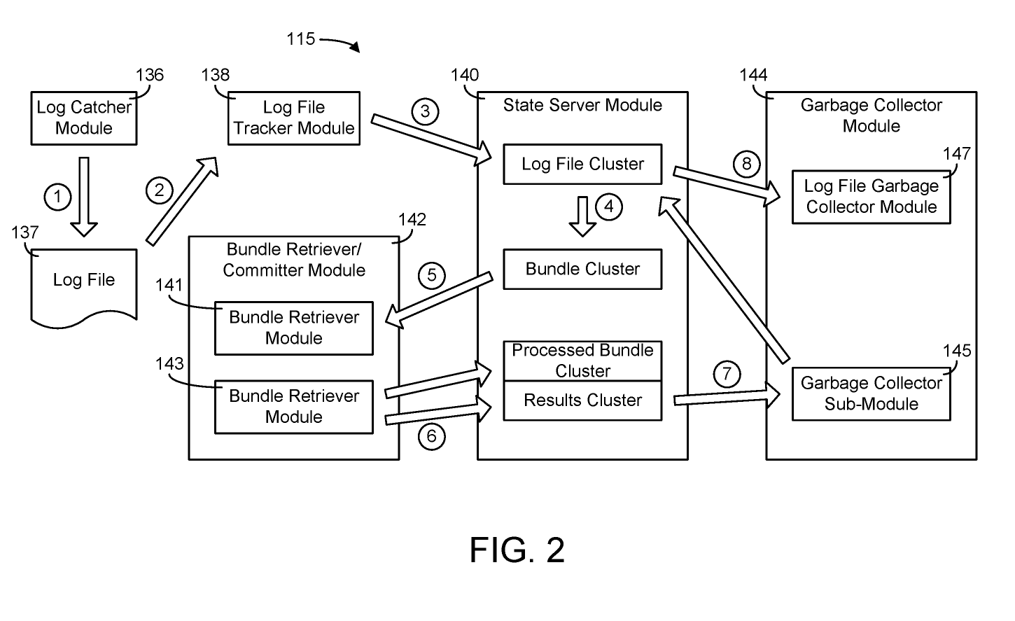

Referring now to FIGS. 1 and 2 together, computer system 100 is shown to include an event logging/processing system 114. As shown in FIG. 1, event logging/processing system 114 may be configured to receive events from other components of computer system 100 and/or from data sources outside system 100 (e.g., via network 102). FIG. 2 is a flow diagram 115 illustrating how event logging/processing system 114 handles received events. Flow diagram 115 is a functional illustration of a processing pipeline through which received events are processed by event logging/processing system 114.

Referring specifically to FIG. 2, event logging/processing system 114 is shown to include a log catcher module 136. Log catcher module 136 may be configured to receive events and write the events to a log file 137 (step 1). Log file 137 may be stored locally (e.g., in a memory device local to event logging/processing system 114) or remotely (e.g., in data storage devices 110). In some implementations, each event stored in log file 137 may be associated with a data offset defining the location of the event in log file 137. The data offsets associated with the events may be stored as log metadata. Log file metadata may be stored as part of log file 137 or separately from log file 137. In other implementations, the data offsets for particular events may be unknown. As log file 137 is processed, the log file data may include alternating blocks of processed bytes and non-processed bytes. The starting data offset for a non-processed block may be known (e.g., based on the ending data offset for the preceding processed block) and used as the data offset for all bytes and/or events in the non-processed block.

Still referring to FIG. 2, event logging/processing system 114 is shown to include a log file tracker module 138 and a state server module 140. Log file tracker module 138 may be configured to read log metadata from log file 137 or otherwise (step 2) and send the log metadata to state server module 140 (step 3). State server module 140 may be configured to split log file 137 into chunks and package events and/or chunks into bundles (step 4). In some implementations, state server module 140 may split log file 137 into chunks according to chunking criteria. The chunking criteria may include instructions for splitting log file 137 into multiple chunks (e.g., based on the log file metadata, based on a preselected or uniform chunk size, based on a predetermined number of events per chunk, etc.). State server module 140 may be configured to package one or more events and/or one or more chunks into bundles. A bundle may include multiple events from the same log file, events from multiple log files, and/or chunks created from one or more log files.

Still referring to FIG. 2, event logging/processing system 114 is shown to include a bundle retriever/committer module 142. In some implementations, bundle retriever/committer module 142 may be split into a bundle retriever module 141 and a bundle committer module 143. Bundle retriever module 141 may be configured to fetch bundles or clusters of bundles from the set of bundles created by state server module 140 for a processing application (step 5). Bundle committer module 143 may be configured to commit the bundles fetched by bundle retriever module 142 for the processing application (step 6). The processing application may use the bundle clusters to generate a results cluster. In some implementations, the processed results may be provided to an application (e.g., an analytics or event monitoring application accessible by content providers 106, user devices 108, or other customers), to content server 112 (e.g., to assist in content selection), or stored in data storage devices 110. In other implementations, the processed results may be communicated to other systems or devices outside computer system 100.

Still referring to FIG. 2, event logging/processing system 114 is shown to include a garbage collector module 144. In some implementations, garbage collector module 144 may be split into an ASU garbage collector module 145 and a log file garbage collector module 147. ASU garbage collector module 145 may be configured to mark the log file clusters which have been processed by the application (step 7) and log file garbage collector 147 may be configured to delete the processed log files (step 8). In some implementations, the data in log file 137 may be completely processed by step 7 and only physical cleanup of log file 137 may be performed in step 8. In other words, step 8 may not significantly affect processing delay, but may nonetheless define when log file 137 is completely processed.

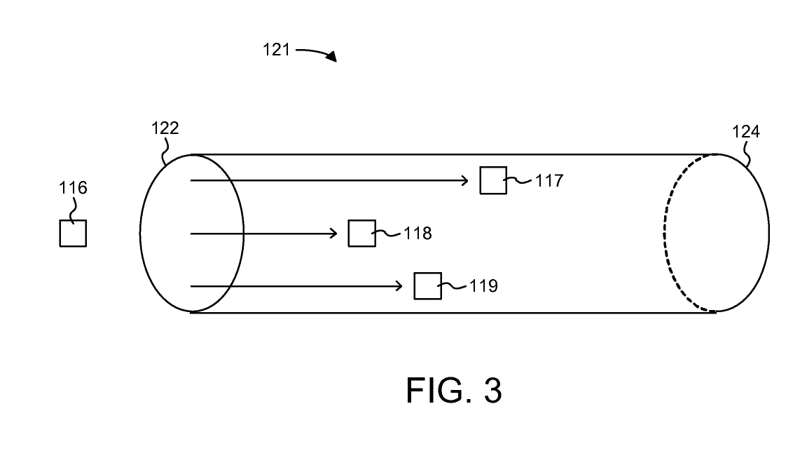

Referring now to FIG. 3, a drawing of a processing pipeline 121 is shown, according to a described implementation. Processing pipeline 121 is a conceptual pipeline which may be used to visualize the flow of event data through event logging/processing system 114. Processing pipeline 121 is shown to include a first end 122, a second end 124, a plurality of events 116, 117, 118, and 119. In some implementations, first end 122 and second end 124 may be defined by steps 1 and 8 respectively. For example, events 116-119 may enter processing pipeline 121 via first end 122 when events 116-119 are written to log file 137 in step 1. Events 116-119 may exit processing pipeline 121 via second end 124 when events 116-119 are deleted from log file 137 in step 8.

Still referring to FIG. 3, processing pipeline 121 is shown at a snapshot in time corresponding to a current time “t_{now}.” At time t_{now}, events 117-119 are within processing pipeline 121 (e.g., between ends 122 and 124) and event 116 is outside processing pipeline 121. Event 116 represents an event which has not yet be written to log file 137 and therefore has not yet entered processing pipeline 121. Events 117-119 represent events which have been written to log file 137 and are various stages within processing pipeline 121 (e.g., steps 2-7).

In some implementations, the time at which an event enters processing pipeline 121 is defined as the event time “tₑᵥₑₙₜ.” Each of events 117-119 may have a different event time tₑᵥₑₙₜ. The respective distances between events 117-119 and first end 122 represent an amount of time which has elapsed since events 117-119 entered processing pipeline 121. For example, event 117 entered processing pipeline 121 prior to events 118-119 and is further along in processing pipeline 121 (e.g., further from end 122). For each of events 117-119, the difference between t_{now} and tₑᵥₑₙₜ may define an individual event processing delay t_{delay} (e.g., t_{delay}=t_{now}−tₑᵥₑₙₜ). An average event processing delay may be expressed as the average of the individual event processing delays for all events in processing pipeline 121. The current time t_{now} may be readily determined (e.g., by referencing a clock, timer, or other time-keeping device) whereas event time tₑᵥₑₙₜ may be unknown.

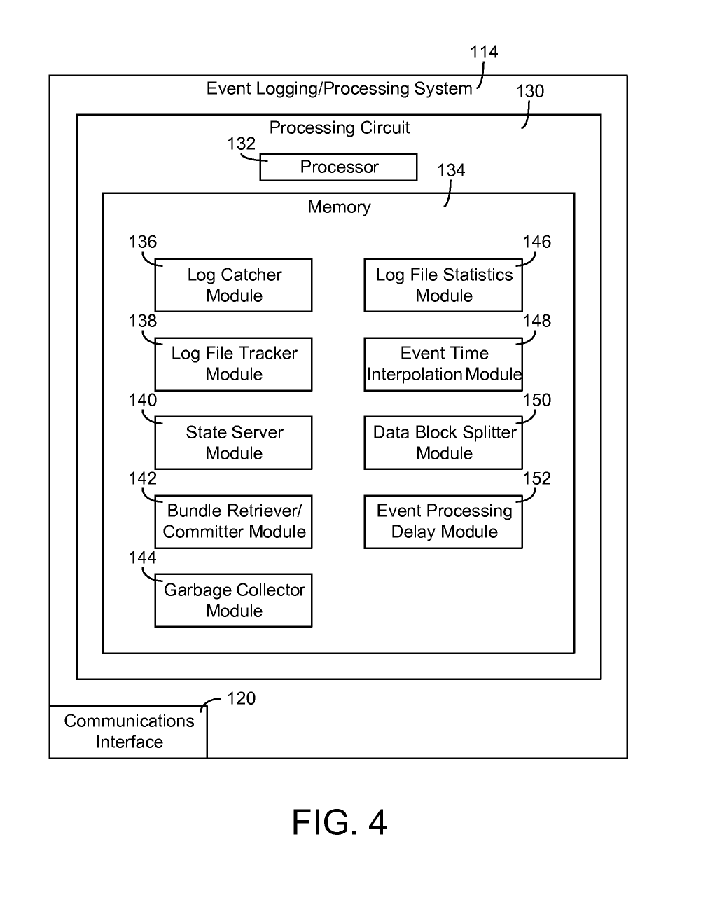

Event logging/processing system 114 may observe the data size of log file 137 at various times as events are written therein and record a statistical data point for each observation. Each of the statistical data points may include a size value indicating a data size of log file 137 and a time value indicating a time at which the size value was observed. Event logging/processing system 114 may be configured to determine the event time tₑᵥₑₙₜ for logged events by interpolating between the statistical data points using byte offsets associated with logged events. The byte offsets may be associated with individual events or with blocks of non-processed bytes including the logged events. Once tₑᵥₑₙₜ is determined, event logging/processing system 114 may calculate event processing delay by subtracting the event time tₑᵥₑₙₜ from the current time t_{now} (e.g., t_{delay}=t_{now}−tₑᵥₑₙₜ). Event logging/processing system 114 is described in greater detail with reference to FIG. 4.

Referring now to FIG. 4, a block diagram illustrating event logging/processing system 114 in greater detail is shown, according to a described implementation. Event logging/processing system 114 is shown to include a communications interface 120 and a processing circuit 130. Communications interface 120 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 120 may allow event logging/processing system 114 to communicate with network 102, resources 104, content providers 106, user devices 108, data storage devices 110, and content server 112.

Still referring to FIG. 4, processing circuit 130 is shown to include a processor 132 and memory 134. Processor 132 may be implemented as a general purpose processor, an application specific integrated circuit (ASIC), one or more field programmable gate arrays (FPGAs), a CPU, a GPU, a group of processing components, or other suitable electronic processing components.

Memory 134 may include one or more devices (e.g., RAM, ROM, flash memory, hard disk storage, etc.) for storing data and/or computer code for completing and/or facilitating the various processes, layers, and modules described in the present disclosure. Memory 134 may comprise volatile memory or non-volatile memory. Memory 134 may include database components, object code components, script components, or any other type of information structure for supporting the various activities and information structures described in the present disclosure. In some implementations, memory 134 is communicably connected to processor 132 via processing circuit 130 and includes computer code (e.g., data modules stored in memory 134) for executing one or more processes described herein.

Memory 134 is shown to include a log catcher module 136, a log file tracker module 138, a state server module 140, a bundle retriever/committer module 142, and a garbage collector module 144. Modules 136-144 may be the same as previously described with reference to FIG. 2. Memory 134 is shown to further include a log file statistics module 146, an event time interpolation module 148, a data block splitter module 150, and an event processing delay module 152.

Still referring to FIG. 4, memory 134 is shown to include a log file statistics module 146. Log file statistics module 146 may be configured to identify a plurality of statistical data points (e.g., p₁, p₂, . . . , pₙ) for log file 137. Each of the statistical data points may include a time value and a corresponding size value. For example, data point p₁ may be expressed as p₁={t₁, s₁}, where the size value s₁ represents an observed file size of log file 137 and the time value t₁ represents a time at which the corresponding size value s₁ was observed. Together, the size value and the time value for a statistical data point may be used to determine the file size of log file 137 at a particular time. The plurality of statistical data points (e.g., p₁-pₙ) may indicate the file size of log file 137 at various times.

In some implementations, log file statistics module 146 is configured to collect the plurality of statistical data points for log file 137. Collecting the plurality of statistical data points may include receiving the data points from an outside data source (e.g., an external file statistics process or service) or obtaining the data points from direct observation of log file 137. For example, in some implementations, log file statistics module 146 observes the file size of log file 137 at a plurality of times and associates each observed file size with the time at which the file size is observed. Observing the file size of log file 137 may be performed by reading, accessing, modifying, or otherwise inspecting log file 137. Log file statistics module 146 may store each observation time and the file size associated with the observation time as a separate data point (e.g., {t₁, s₁}, {t₂, s₂}, {t₃, s₃} . . . {tₙ, sₙ}).

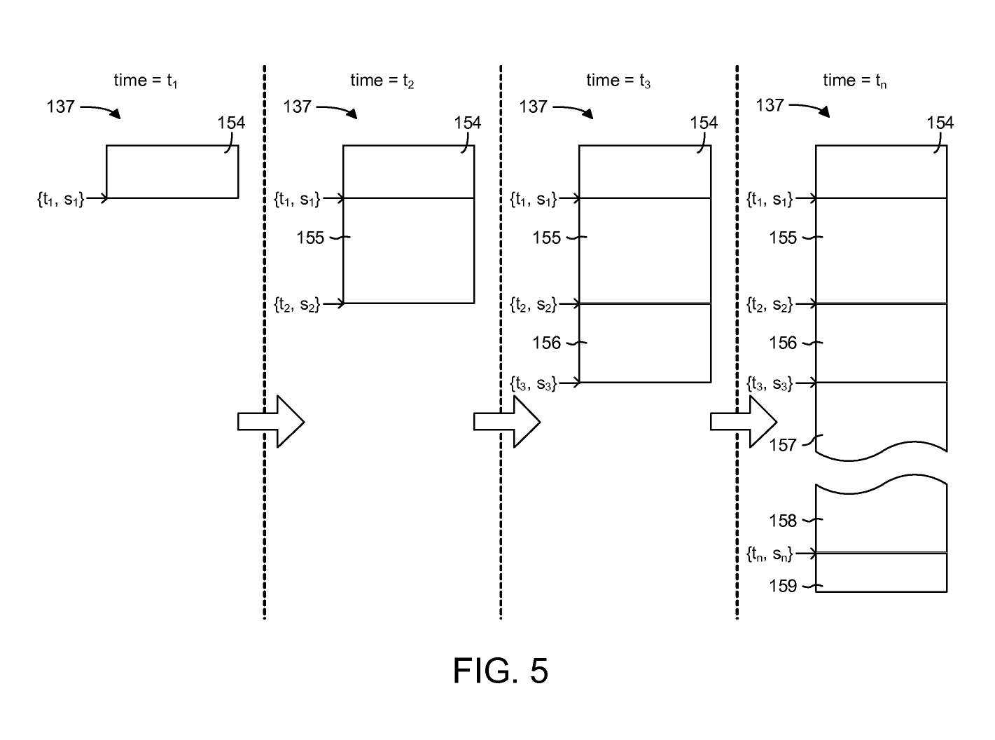

Referring now to FIG. 5, a drawing of log file 137 marked with a plurality of statistical data points is shown, according to a described implementation. As events are written to log file 137, the file size of log file 137 increases. For example, at time t₁, log file 137 may have a first file size s₁ and at time t₂, log file 137 may have a second file size s₂, where t₂>t₁ and s₂≥s₁. As events are added to log file 137, the file size of log file 137 may continue to increase to a third file size s₃ at time t₃, and eventually to a nth file size sₙ at time tₙ. At each of times t₁-tₙ, the file size of log file 137 may be recorded. Log file 137 is shown with markings corresponding to each time-size pair. In some implementations, times t₁-tₙ may be distributed uniformly. For example, the file size of log file 137 may be observed with regularity based on a set sampling frequency (e.g., once every ten seconds, once per minute, once per second, etc.). In other implementations, times t₁-tₙ may be non-uniform and the file size of log file 137 may be observed at irregular intervals.

The plurality of statistical data points may be used to establish a framework for mapping bytes of log file 137 to a particular time. For example, if a data block within log file 137 has a starting data offset and an ending data offset between s₁ and s₂, it may be determined that the events within the data block were written to log file 137 between times t₁ and t₂. By interpolating between s₁ and s₂, an estimated event time may be determined for the events within the data block.

Still referring to FIG. 5, the plurality of statistical data points p₁-pₙ may divide log file 137 into a plurality of discrete portions 154-159. The number of discrete portions 154-159 may be based on the number of the plurality of statistical data points p₁-pₙ. For example, if n statistical data points are collected, log file 137 may be divided into n+1 discrete portions. Discrete portion 154 may include the bytes/events written to log file 137 between the time that log file 137 is initially created and time t₁. Discrete portion 155 may include the bytes/events written to log file 137 between the times t₁ and t₂. Discrete portion 156 may include the bytes/events written to log file 137 between the times t₂ and t₃. Discrete portions 157-158 may include the bytes/events written to log file 137 between the times t₃ and tₙ. Discrete portion 159 may include the bytes/events written to log file 137 after time tₙ.

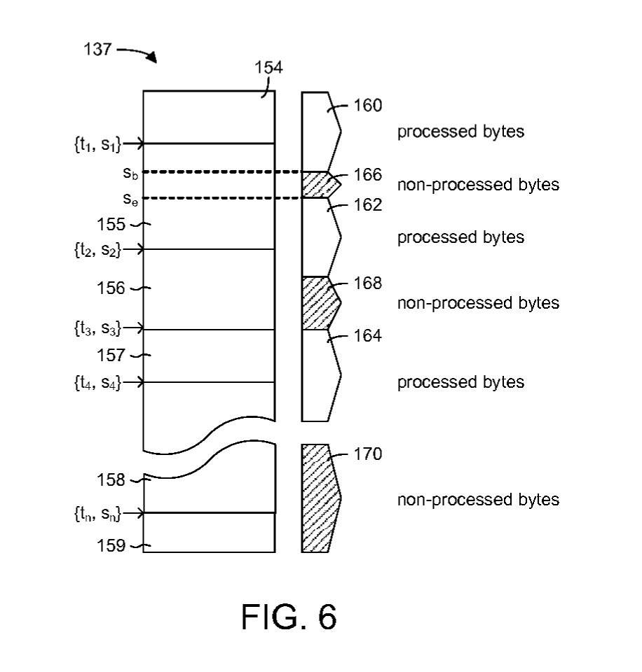

Referring now to FIG. 6, a drawing of log file 137 marked with alternating blocks of processed and non-processed bytes is shown, according to a described implementation. Prior to processing, log file 137 may consist entirely of non-processed bytes. As log file 137 is processed, the processed bytes may be marked as processed (e.g., by garbage collector module 144). In some implementations, garbage collector module 144 marks processed bytes by recording a starting data offset and/or an ending data offset for blocks of processed bytes (e.g., processed blocks 160, 162, and 164). Naturally, as processed blocks 160-164 are processed, an alternating series of processed blocks and non-processed blocks (e.g., non-processed blocks 166, 168, and 170) may be created. Blocks 160-170 may be of any size and may include any number of bytes. As log file 137 is processed, the number or size of processed blocks 160-164 may increase whereas the number or size of non-processed blocks 166-170 may decrease. When processing is completed all bytes within log file 137 may be marked as processed and log file 137 may be deleted.

In some implementations, log file statistics module 146 is configured to identify blocks of processed and non-processed bytes in log file 137 while log file 137 is undergoing processing. Log file statistics module 146 may identify blocks of processed bytes (e.g., blocks 160-164) using the starting and/or ending data offsets marked by garbage collector module 144. In some implementations, log file statistics module 146 identifies non-processed blocks (e.g., blocks 166-170) using the starting and/or ending data offsets associated with adjacent processed blocks. For example, the starting data offset for a non-processed block (e.g., non-processed block 166) may be the next byte following the ending data offset for the processed block immediately preceding the non-processed block (e.g., processed block 160). The ending data offset for a non-processed block may be the byte preceding the starting data offset for the processed block immediately following the non-processed block.

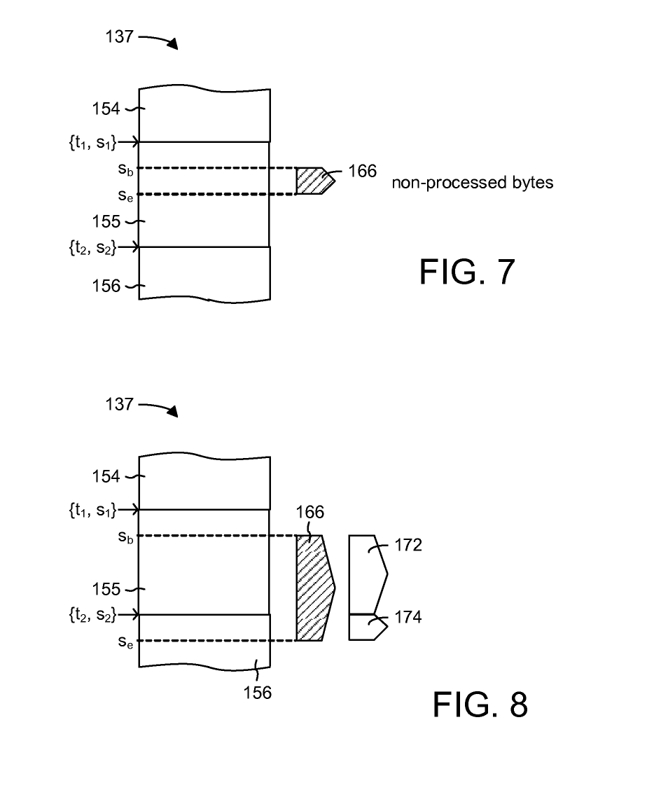

Log file statistics module 146 may be configured to identify starting and/or ending data offsets for non-processed blocks 166-170. As shown in FIG. 6, non-processed block 166 may be identified as having a starting data offset s_{b} and an ending data offset sₑ, where sₑ≥s_{b}. In some instances, both s_{b} and sₑ may be between consecutive observed log file size values (e.g., within the same discrete portion). For example, both s_{b} and sₑ may be between s₁ and s₂ (e.g., s₁≤s_{b}≤sₑ≤s₂, within discrete portion 155). In other instances, s_{b} and sₑ may span one or more observed log file size values (e.g., s₁≤_{b}≤s₂≤sₑ) and may be in different portions of discrete portions 154-159. These possibilities are described in greater detail with reference to FIGS. 7-9.

Referring now to FIG. 7, a drawing of a section of log file 137 is shown, according to a described implementation. Log file 137 is shown to include a block 166 of non-processed bytes having a starting data offset s_{b} and an ending data offset sₑ. The values for s_{b} and sₑ may be known or determined by log file statistics module 146, as previously described. Both the starting data offset s_{b} and the ending data offset sₑ for non-processed block 166 are shown between s₁ and s₂ within discrete portion 155.

Event time interpolation module 148 may be configured to determine an event time tₑᵥₑₙₜ for events logged in non-processed blocks (e.g., blocks 166-170). As previously noted, the event time tₑᵥₑₙₜ for an event may be defined as the time when the event is written to log file 137. In some implementations, event time interpolation module 148 may assume that all bytes/events in a non-processed block have the same event time tₑᵥₑₙₜ. Accordingly, each of non-processed blocks 166-170 may be described as having a single event time tₑᵥₑₙₜ. Event time interpolation module 148 may determine the event time tₑᵥₑₙₜ using the mapping of log file sizes and times provided by the plurality of data points {t₁, s₁}, {t₂, s₂}, {t₃, s₃} . . . {tₙ, sₙ}.

In some implementations, event time interpolation module 148 may determine that the event time tₑᵥₑₙₜ for a non-processed block is the most recent file size observation time (e.g., t₁-tₙ) preceding the non-processed block. For example, non-processed block 166 may be assigned an event time tₑᵥₑₙₜ=t₁ because t₁ is the most recent file size observation time preceding non-processed block 166. Using the most recent file size observation time preceding a non-processed block for tₑᵥₑₙₜ is a pessimistic assumption because it may result in events being assigned an event time tₑᵥₑₙₜ earlier than the actual time the events were written to log file 137. The earlier event time tₑᵥₑₙₜ may cause the computed event processing delay t_{delay} (e.g., t_{delay}=t_{now}−tₑᵥₑₙₜ) to be larger than the actual event processing delay. However, it may be desirable to make pessimistic assumptions rather than optimistic assumptions to prevent a false indication that the system is healthier than it actually is.

In other implementations, event time interpolation module 148 may determine that the event time tₑᵥₑₙₜ for a non-processed block is the time at which the earliest byte of the non-processed block was written to log file 137. The earliest byte of a non-processed block may be identified by the starting data offset for the non-processed block. For example, the earliest byte of non-processed block 166 may be identified by starting data offset s_{b}. While this is still a pessimistic assumption regarding almost all of the events recorded in the non-processed block, using a time associated with the starting data offset s_{b} may be substantially more accurate than using the time of the most recent file size observation. The time “t_{b}” associated with the starting data offset s_{b} may be an estimation of a time when log file 137 had a file size of s_{b}.

Event time interpolation module 148 may determine time t_{b} by interpolating between the plurality of statistical data points p₁-pₙ. For example, time t_{b} may be calculated using the following formula:

$${t}_{b} = {t}_{1} + \frac{( {t}_{2} - {t}_{1} ) \cdot ( {s}_{b} - {s}_{1} )}{{s}_{2} - {s}_{1}}$$

where

$$\frac{{s}_{b} - {s}_{1}}{{s}_{2} - {s}_{1}}$$

represents a data offset proportion (e.g., the ratio of the difference between s_{b} and s₁ to the difference between s₂ and s₁). The data offset proportion

$$\frac{{s}_{b} - {s}_{1}}{{s}_{2} - {s}_{1}}$$

can be multiplied by the difference between t₂ and t₁ to identify a time value proportion (e.g., the proportion of the time interval t₁-t₂ occurring after time t₁ before log file 137 had a file size of s_{b}). The time value proportion can then be added to time t₁ to determine time t_{b}. In some implementations, time t_{b} may not depend on the ending data offset sₑ because all bytes within the non-processed block may be assumed to have an event time corresponding to the time t_{b} at which the earliest byte in the non-processed block was written, regardless of the size of the block or the ending data offset sₑ.

Referring now to FIG. 8, another drawing of a section of log file 137 is shown, according to a described implementation. Log file 137 is shown to include a block 166 of non-processed bytes having a starting data offset s_{b} and an ending data offset sₑ. The values for s_{b} and sₑ may be known or determined by log file statistics module 146, as previously described. In FIG. 8, the starting data offset s_{b} and the ending data offset sₑ are located in different portions of log file 137. In other words, at least one of the plurality of data points has a size value sₓ between s_{b} and sₑ (e.g., s_{b}≤sₓ≤sₑ). For example, the starting data offset s_{b} is shown between s₁ and s₂ (e.g., within portion 155) whereas the ending data offset sₑ is shown between s₂ and s₃ (e.g., within discrete portion 156).

Data block splitter module 150 may be configured to determine whether a non-processed block spans multiple discrete portions 154-159 of log file 137. A block which spans multiple discrete portions 154-159 may be defined as a block having a starting data offset s_{b} and an ending data offset sₑ in different discrete portions 154-159, as shown in FIG. 8. Data block splitter module 150 may be configured to divide a data block spanning multiple discrete portions into a plurality of sub-blocks. For example, data block splitter module 150 may divide non-processed block 166 into multiple sub-blocks 172 and 174.

In some implementations, data block splitter module 150 may divide a block spanning multiple discrete portions at the size locations defined by the one or more observed size values s₁-sₑ between s_{b} and sₑ. Dividing a block at size locations defined by the one or more observed size values s₁-sₑ may ensure that each of the sub-blocks is contained within a single discrete portion. For example, sub-block 172 may be contained entirely within discrete portion 172 and sub-block 174 may be contained entirely within discrete portion 174.

When a non-processed block spans multiple discrete portions 154-159, event time interpolation module 148 may determine event time tₑᵥₑₙₜ for the block using a weighted average of event times for each of the sub-blocks created by data block splitter 150. For example, the event time tₑᵥₑₙₜ for non-processed block 166 as shown in FIG. 8 may be a weighted average of a first event time t_{event,1} associated with sub-block 172 and a second event time t_{event,2} associated with sub-block 174.

The first event time t_{event,1} associated with sub-block 172 may be the time t_{b} associated with the starting data offset s_{b} (e.g., t_{event,1}=t_{b}). Time t_{b} may be determined (e.g., by event time interpolation module 148) using the same interpolative process described with reference to FIG. 7. For example, time t_{b} may be calculated using the formula:

$${t}_{b} = {t}_{1} + \frac{( {t}_{2} - {t}_{1} ) \cdot ( {s}_{b} - {s}_{1} )}{{s}_{2} - {s}_{1}}$$

The second event time t_{event,2} associated with sub-block 174 may be the time at which the earliest byte of sub-block 174 was written to log file 137. For implementations in which block 166 is divided into sub-blocks defined by the one or more observed size values, the time at which the earliest byte of sub-block 174 was written to log file 137 may coincide with observation time t₂ (e.g., t_{event,2}=t₂). The weighted average for the event time tₑᵥₑₙₜ (e.g., the weighted average event time for the events in non-processed block 166) may be expressed as:

$${t}_{event} = \frac{{t}_{event , 1} \cdot ( {s}_{2} - {s}_{b} ) + {t}_{event , 2} \cdot ( {s}_{e} - {s}_{2} )}{{s}_{e} - {s}_{b}}$$

where the weights applied to the terms t_{event,1} and t_{event,2} are the respective proportions of bytes within sub-blocks 172 and 174 to the total number of bytes in non-processed block 166.

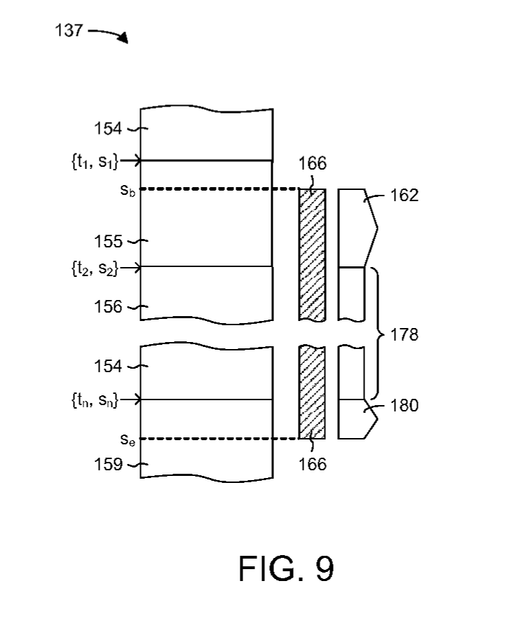

Referring now to FIG. 9, another drawing of a section of log file 137 is shown, according to a described implementation. In FIG. 9, non-processed block 166 is shown spanning n discrete portions 154-159, where n>2. When a non-processed data block spans three or more discrete portions 154-159, data block splitter module 150 may divide the non-processed data block into three or more sub-blocks. For example, non-processed block 166 is shown divided into a first sub-block 176, one or more intermediate sub-blocks 178, and a last sub-block 180.

First sub-block 176 and last sub-block 180 may be the same or similar to sub-blocks 172 and 174 (respectively) as described with reference to FIG. 8. Sub-blocks 178 may include one or more sub-blocks, where the number x of sub-blocks included in sub-blocks 178 is two less than the number of discrete data portions n spanned by non-processed block 166 (e.g., x=n−2). For example, if non-processed block 166 spans three discrete portions (e.g., n=3), sub-blocks 178 may include a single sub-block (e.g., x=1); if non-processed block 166 spans four discrete portions(e.g., n=4), sub-blocks 178 may include two sub-blocks (e.g., x=2); etc.

When a non-processed block spans three or more discrete portions 154-159, the event time tₑᵥₑₙₜ for the block may be determined using a weighted average of event times for each of the sub-blocks created by data block splitter 150. For example, the event time tₑᵥₑₙₜ for non-processed block 166 as shown in FIG. 9 may be a weighted average of a first event time t_{event,1} associated with sub-block 176, one or more intermediate event times t_{event,2}-t_{event,n-1} associated with one or more intermediate sub-blocks 178, and a last event time t_{event,n} associated with last sub-block 180.

The first event time t_{event,1} associated with sub-block 176 may be the time t_{b} associated with the starting data offset s_{b} (e.g., t_{event,1}=t_{b}). Time t_{b} may be determined (e.g., by event time interpolation module 148) using the same interpolative process described with reference to FIG. 7. For example, time t_{b} may be calculated using the formula:

$${t}_{b} = {t}_{1} + \frac{( {t}_{2} - {t}_{1} ) \cdot ( {s}_{b} - {s}_{1} )}{{s}_{2} - {s}_{1}}$$

The last event time t_{event,n} associated with last sub-block 180 may be the time at which the earliest byte of last sub-block 180 was written to log file 137. For implementations in which block 166 is divided into sub-blocks defined by the one or more observed size values, the time at which the earliest byte of last sub-block 180 was written to log file 137 may coincide with observation time tₙ (e.g., t_{event,n}=tₙ).

The one or more intermediate event times t_{event,2}-t_{event,n-1} associated with one or more sub-blocks 178 may be the times at which the earliest bytes of each of sub-blocks 178 were written to log file 137. For example, event time t_{event,2} may be observation time t₂ and event time t_{event,3} may be observation time t₃. This pattern may continue through event time t_{event,n-1}, which may be observation time tₙ₋₁.

Event time interpolation module 148 may determine tₑᵥₑₙₜ by combining event times t_{event,1}-t_{event,n} into a weighted average event time. The weight assigned to an event time in the weighted average may correspond to a relative proportion of bytes within the sub-block associated with the event time to the total number of bytes in the non-processed block. For example, event time t_{event,1} may be assigned a weight of

$$\frac{{s}_{2} - {s}_{b}}{{s}_{e} - {s}_{b}} ,$$

each event time t_{event,x} for 2≤x≤n−1 may be assigned a weight of

$$\frac{{s}_{x + 1} - {s}_{x}}{{s}_{e} - {s}_{b}} ,$$

and event time t_{event,n} may be assigned a weight of

$$\frac{{s}_{e} - {s}_{n}}{{s}_{e} - {s}_{b}} .$$

Event time interpolation module 148 may compute the weighted average using the following formula:

$${t}_{event} = \frac{{t}_{event , 1} \cdot ( {s}_{2} - {s}_{b} ) + {\sum }_{x = 2}^{n - 1} {t}_{event , x} ( {s}_{x + 1} - {s}_{x} ) + {t}_{event , n} \cdot ( {s}_{e} - {s}_{n} )}{{s}_{e} - {s}_{b}}$$

where the event time tₑᵥₑₙₜ is the weighted average event time for events in the non-processed block.

Event time interpolation module 148 may determine an event time tₑᵥₑₙₜ for each non-processed block in log file 137 and/or non-processed blocks other log files currently undergoing processing in processing pipeline 121. Event time interpolation module 148 may output the determined event time tₑᵥₑₙₜ to event processing delay module 152.

Event processing delay module 152 may be configured to determine an event processing delay t_{delay} for each event time tₑᵥₑₙₜ received from event time interpolation module 148. In some implementations, event processing delay module 152 computes the event processing delay t_{delay} using the equation t_{delay}=t_{now}−tₑᵥₑₙₜ, where t_{now} is a current time. Event processing delay module 152 may determine an average delay time t_{delay,avg} by averaging the individual event processing delays for each non-processed data block in processing pipeline 121. In some implementations, event processing delay module 152 may average the event processing delays using the formula:

$${t}_{delay , avg} = {\sum }_{i = 1}^{z} \frac{{t}_{delay , i}}{z}$$

where z is the total number of non-processed blocks or sub-blocks in processing pipeline 121, t_{delay,i} is the event processing delay associated with the ith non-processed block or sub-block, and 1≤i≤z.

In some implementations, event time interpolation module 148 and event processing delay module 152 work together to determine the average delay time t_{delay,avg}. For example, as described above, computing t_{delay,avg} may be accomplished by estimating an event time for each non-processed sub-block (e.g., t_{event,1} . . . t_{event,n}), combining the estimated event times into a plurality of weighted average event times tₑᵥₑₙₜ (e.g., one weighted average event time for each block of non-processed bytes), determining a delay time t_{delay} for each block of non-processed bytes (e.g., t_{delay}=t_{now}−tₑᵥₑₙₜ), and averaging the delay times for each block of non-processed bytes to determine the average delay time t_{delay,avg}

$$( e . g . , {t}_{delay , avg} = {\sum }_{i = 1}^{z} \frac{{t}_{delay , i}}{z} ) .$$

This approach may compute the average delay time t_{delay,avg} without considering the size that each non-processed block contributes to the overall total of non-processed bytes.

In some implementations, event processing delay module 152 may determine a more accurate estimate of the average delay time t_{delay,avg} using a weighted average event time across all of the blocks of non-processed bytes. For example, event time interpolation module 148 may combine the event times for each non-processed sub-block in all of the non-processed blocks (e.g., t_{event,1} . . . t_{event,n} for sub-blocks in a first non-processed block, t_{event,1} . . . t_{event,m} for sub-blocks in a second non-processed block, etc.) into a single weighted average event time tₑᵥₑₙₜ for all of the non-processed blocks or sub-blocks in processing pipeline 121. The weighted average may be based on the size of each non-processed block relative to the overall total size of non-processed bytes. Event processing delay module 152 may use the single weighted average event time tₑᵥₑₙₜ to compute the average delay time t_{delay,avg} (e.g., t_{delay,avg}=t_{now}−tₑᵥₑₙₜ). This approach may consider the size that each non-processed block or sub-block contributes to the overall total of non-processed bytes when computing the average delay time t_{delay,avg}.

In some implementations, event processing delay module 152 determines an event processing delay for all of the unprocessed bytes in processing pipeline 121 (e.g., using a weighted average technique as described above). In other implementations, event processing delay module determines an event processing delay for a percentage (e.g., 80%, 90%, 95%, 99%, etc.) of the non-processed bytes in processing pipeline 121. For example, a 90th percentile event processing delay may correspond to a delay time which accounts for 90% of the unprocessed bytes in processing pipeline 121. Determining an event processing delay for a particular percentage of the non-processed bytes (e.g., the fastest 90%, the fastest 95%, etc.) may be useful for reducing or eliminating the effects of outliers (e.g., sub-blocks having an extraordinarily high processing delay time) when calculating the event processing delay. Event processing delay module 152 may use the percentile event processing delay in place of or in addition to the weighted average event processing delay.

In some implementations, event processing delay module 152 may construct a histogram of non-processed bytes. The histogram of non-processed bytes may be used to identify an event processing delay for a percentage of the non-processed bytes. Each sub-block of non-processed bytes may be represented in the histogram based on a data size sᵢ and a sub-block-specific delay time t_{delay,i} associated with the sub-block. In some implementations, each sub-block of non-processed bytes may be assigned an event time t_{event,i} by event time interpolation module 148 and a sub-block-specific delay time t_{delay,i} by event processing delay module 152 (e.g., t_{delay,i}=t_{now}−t_{event,i}). After assigning a delay time to each sub-block, each sub-block of non-processed bytes may have a data size sᵢ and a sub-block-specific delay time t_{delay,i}.

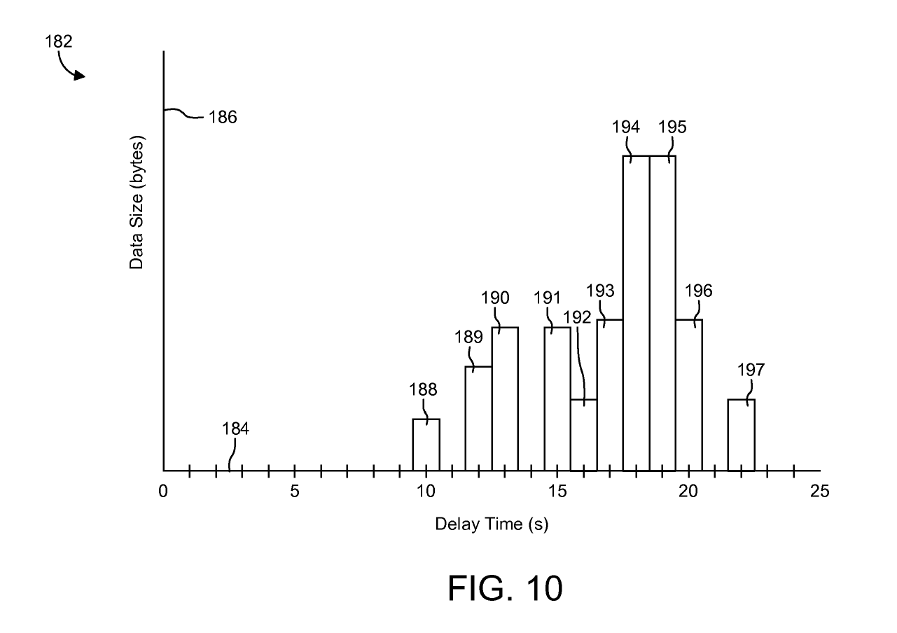

Referring now to FIG. 10, a histogram 182 of non-processed bytes is shown, according to a described implementation. Histogram 182 is shown as a two-dimensional graph having delay time plotted along x-axis 184 and data size plotted along y-axis 186. Histogram 182 is shown to include a plurality of bars 188-196 representing a plurality of sub-blocks currently undergoing processing by processing pipeline 121. The size and position of bars 188-197 may be based on the data size sᵢ and a sub-block-specific delay time t_{delay,i} associated with each of the plurality of sub-blocks represented by bars 188-197.

As shown in FIG. 10, bar 188 may represent a sub-block having a data size of 25 bytes and a delay time of 10 seconds. Bar 189 may represent a sub-block having a data size of 75 bytes and a delay time of 12 seconds. Bar 190 may represent a sub-block having a data size of 100 bytes and a delay time of 13 seconds. Bar 191 may represent a sub-block having a data size of 100 bytes and a delay time of 15 seconds. Bar 192 may represent a sub-block having a data size of 50 bytes and a delay time of 16 seconds. Bar 193 may represent a sub-block having a data size of 100 bytes and a delay time of 17 seconds. Bar 194 may represent a sub-block having a data size of 200 bytes and a delay time of 18 seconds. Bar 195 may represent a sub-block having a data size of 200 bytes and a delay time of 19 seconds. Bar 196 may represent a sub-block having a data size of 100 bytes and a delay time of 20 seconds. Bar 197 may represent a sub-block having a data size of 50 bytes and a delay time of 22 seconds. The total data size of the sub-blocks represented by bars 188-197 is 1000 bytes.

Histogram 182 may be used to identify a delay time for a particular percentage of non-processed bytes. In some implementations, the percentile delay time may correspond to a delay time that is greater than or equal to the delay times associated with the particular percentage of the non-processed bytes. For example, if 95% of the non-processed bytes have a delay time less than or equal to 20 seconds, the delay time corresponding to the 95th percentile of non-processed bytes may be 20 seconds.

Still referring to FIG. 10, identifying the delay time associated with a particular percentage of the non-processed bytes may be accomplished by increasing the delay time (e.g., moving to the right along delay time axis 184) until the sum of all the bytes to the left of the current delay time is equal to the particular percentage of the total bytes in histogram 182 (e.g., the total size of the non-processed bytes in histogram 182 multiplied by the particular percentage). For example, multiplying a total data size of 1000 bytes by the percentage 95% results in a 95th percentile data size value of 950 bytes. As shown in histogram 182, the fastest 950 bytes have a maximum delay time of 20 seconds. Only 50 bytes (e.g., represented by bar 197) have a delay time greater than 20 seconds. Therefore, the 95th percentile delay time of the non-processed bytes represented in histogram 182 is 20 seconds. Event processing delay module 152 may use the percentile event processing delay in place of or in addition to the average event processing delay t_{delay,avg}.

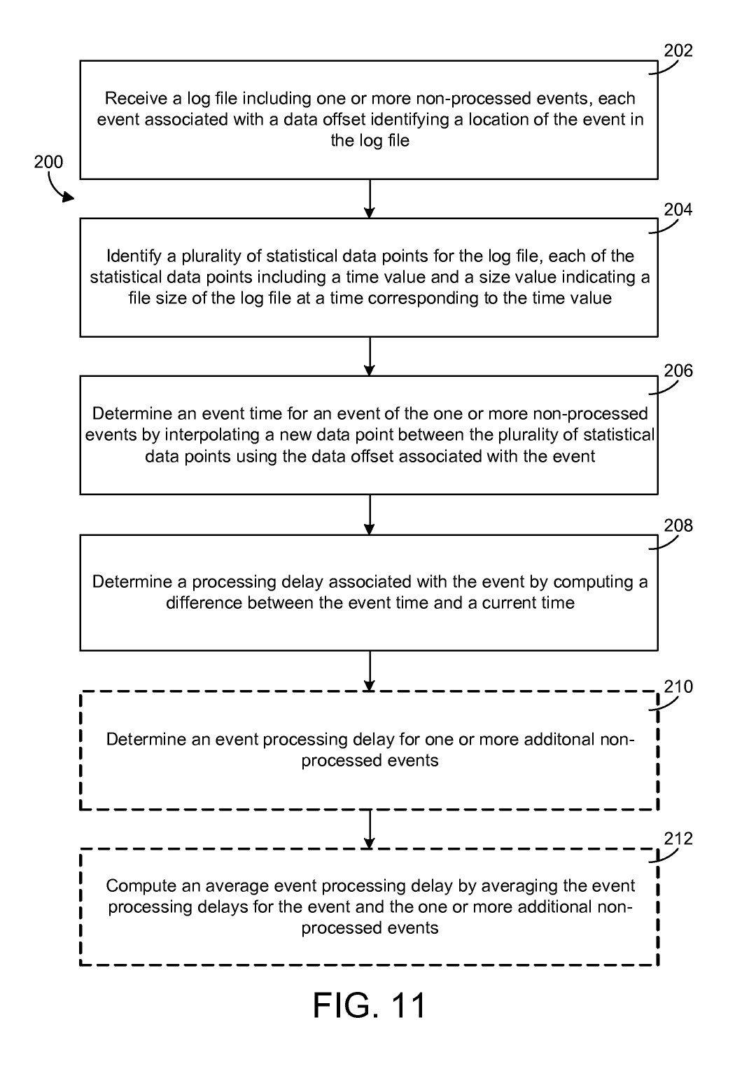

Referring now to FIG. 11, a flowchart of a process 200 for determining an event processing delay is shown, according to a described implementation. Process 200 may be performed by event logging/processing system 114 using one or more of the memory modules described with reference to FIGS. 3-4. Process 200 may be used to determine an event processing delay for non-processed events (e.g., logged events currently awaiting or undergoing processing). This advantage allows the event processing delay for an event to be determined before processing of the event is completed and provides improved performance over traditional systems and methods which only produce post-processing results. By computing the event processing delay for events currently undergoing processing (e.g., in a processing pipeline 21), process 200 can generate more accurate and contemporaneous results than can be generated by traditional systems and methods.

Still referring to FIG. 11, process 200 is shown to include receiving a log file including one or more non-processed events, each event associated with a data offset identifying a location of the event in the log file (step 202). In general, an event may be a data element representing an occurrence, an action, a measurement, or other receipt of data. In a computer environment such as computer system 100, an event may be generated by network 102, resources 104, content providers 106, user devices 108, data storage devices 110 and/or content server 112 upon detecting that a particular action has been performed (e.g., clicking on a link, viewing an online resource, submitting a search request, requesting a content item, etc.).

For example, resources 104 may generate events when resource content is viewed, requested, presented, accessed, or in response to any other type of action or occurrence with respect to resource content (e.g., pageview events). Resources 104 may generate events associated with third party content items presented via resources 104 (e.g., impression events, click events, etc.). In some implementations, resources 104 generate conversion events in response to an action or behavior (e.g., by user devices 108) which satisfies conversion criteria (e.g., online purchases, click-through paths, etc.).

User devices 108 may generate events in response to a detected interaction with a content item. The event may include a plurality of attributes including a content identifier (e.g., a content ID or signature element), a device identifier, a referring URL identifier, an event timestamp, or any other attributes describing the interaction. User devices 108 may generate events when particular actions are performed by a user device (e.g., resource views, online purchases, search queries submitted, etc.).

Events may be generated in response to a wide variety of occurrences and/or incidents (e.g., an alarm, an alert, receipt of network data, an email, a notification, a transaction, a server restart, etc.) and may be triggered by manual or automated actions. Events may be generated by components of system 100 or by data sources outside system 100 and may be communicated to event logging/processing system 114 via network 102.

Events communicated to event logging/processing 114 system may be stored in log files while awaiting processing. Log files (e.g., log file 137) may be stored locally (e.g., in a memory device local to event logging/processing system 114) or remotely (e.g., in data storage devices 110). Events may include at least one time-based attribute or dimension. The time-based attribute or dimension may indicate a time at which the event occurred, a time at which the event is received by the logging/processing system, or another time metric associated with the occurrence, logging, or processing of the event.

In some implementations, each event stored in log file 137 is associated with a data offset defining the location of the event in log file 137. The data offsets associated with the events may be stored as log metadata. Log file metadata may be stored as part of log file 137 or separately from log file 137. In some implementations, the data offsets for individual events may be known and an exact position of the events in log file 137 may be determined.

In other implementations, the data offsets for individual events may be unknown and the data offset associated with an event may be a data offset for a block of non-processed bytes of the log file. The data offset for the block of non-processed bytes may be the data offset associated with each of the events in the block of non-processed bytes (e.g., with multiple events having the same data offset). As log file 137 is processed, the log file data may include alternating blocks of processed bytes and non-processed bytes. The starting data offset for a block of non-processed may be known or determined (e.g., based on the ending data offset for the preceding processed block) and used as the data offset for all bytes and/or events in the non-processed block.

Still referring to FIG. 11, process 200 is shown to include identifying a plurality of statistical data points for the log file, each of the statistical data points including a time value and a size value (step 204). The size value may indicate a file size of the log file at a time corresponding to the time value. As events are written to log file 137, the file size of log file 137 increases. For example, at time t₁, log file 137 may have a first file size s₁ and at time t₂, log file 137 may have a second file size s₂, where t₂>t₁ and s₂≥s₁. As events are added to log file 137, the file size of log file 137 may continue to increase to a third file size s₃ at time t₃, and eventually to a nth file size sₙ at time tₙ. Data point p₁ may be expressed as p₁={t₁, s₁}, where the size value s₁ represents an observed file size of log file 137 and the time value t₁ represents a time at which the corresponding size value s₁ was observed. Together, the size value and the time value for a statistical data point may be used to determine the file size of log file 137 at a particular time. The plurality of statistical data points (e.g., p₁-pₙ) may indicate the file size of log file 137 at various times.

In some implementations, the plurality of statistical data points may be received from an external data source (e.g., an external file statistics service or process). In other implementations, step 204 includes collecting the plurality of statistical data points for the log file. Collecting the plurality of statistical data points may include obtaining or measuring the data points from direct observation of log file 137. For example, in some implementations, step 204 includes observing the file size of log file 137 at a plurality of times and associating each observed file size with the time at which the file size is observed. Observing the file size of log file 137 may be performed by reading, accessing, modifying, or otherwise inspecting log file 137. Each observation time and the file size associated with the observation time may be stored as a separate data point (e.g., {t₁, s₁}, {t₂, s₂}, {t₃, s₃} . . . {tₙ, sₙ}).

In some embodiments, process 200 includes marking log file 137 with a plurality of statistical data points. The plurality of statistical data points may be used to establish a framework for mapping bytes of log file 137 to a particular time. For example, if a data block within log file 137 has a starting data offset and an ending data offset between s₁ and s₂, it may be determined that the events within the data block were written to log file 137 between times t₁ and t₂. By interpolating between s₁ and s₂, an estimated event time may be determined for the events within the data block. The accuracy of the estimate may be controlled by adjusting a rate at which the plurality of statistical data points are collected. A faster data collection rate may result in more statistical data points and thereby improve the accuracy of the interpolation therebetween.

Still referring to FIG. 11, process 200 is shown to include determining an event time for an event of the one or more non-processed events by interpolating a new data point between the plurality of statistical data points using the data offset associated with the event (step 206). The new data point may have an interpolated time value which is interpolated using the data offset associated with the event. In some implementations, the data offset associated with the event may be a starting data offset s_{b} for a block of non-processed bytes in which the event is located (e.g., in log file 137). The interpolated time value t_{b} may be an interpolated estimate of a time at which the log file had a file size of s_{b}.

In some implementations, the plurality of statistical data points include a first data point having a first time value and a first size value (e.g., p₁={t₁, s₁}) and a second data point having a second time value and a second size value (e.g., p₂={t₂, s₂}). The data offset s_{b} associated with the event may be greater than or equal to the first size value and less than or equal to the second size value (e.g., s₁≤s_{b}≤s₂). The interpolated time value t_{b} may be determined by interpolating between the plurality of statistical data points using the following formula:

$${t}_{b} = {t}_{1} + \frac{( {t}_{2} - {t}_{1} ) \cdot ( {s}_{b} - {s}_{1} )}{{s}_{2} - {s}_{1}}$$

In some implementations, step 208 includes identifying the interpolated time value t_{b} as the event time tₑᵥₑₙₜ. However, step 208 may be performed differently for an event in a block of non-processed bytes which spans multiple discrete portions of the log file than for an event in a block of non-processed bytes which does not span multiple discrete portions of the log file.

In some implementations, process 200 includes determining whether the event is in a block of non-processed bytes which spans multiple discrete portions of the log file or whether the event is in a block of non-processed bytes which does not span multiple discrete portions of the log file. A block may be defined as spanning multiple discrete portions of the log file if the size value of one or more of the statistical data points (e.g., s₁-sₑ) is between the starting data offset s_{b} and the ending data offset sₑ of the block of non-processed bytes.

In some implementations, if the event is in a block of non-processed bytes which does not span multiple discrete portions of the log file, step 208 includes identifying the interpolated time value t_{b} as the event time tₑᵥₑₙₜ. However, if the event is in a block of non-processed bytes which spans multiple discrete portions of the log file, step 208 may include dividing the block of non-processed bytes into multiple sub-blocks, determining a sub-event time for each of the multiple sub-blocks, and determining the event time by computing a weighted average of the multiple sub-event times. The weighted average may be a weighted average event time for the events in the block of non-processed bytes.

For example, the event time tₑᵥₑₙₜ for a non-processed block spanning two discrete portions of log file 137 (e.g., s₁≤s_{b}≤s₂≤sₑ≤s₃ as shown in FIG. 8) may be a weighted average of a first event time t_{event,1} associated with a first sub-block and a second event time t_{event,2} associated with a second sub-block. The event time t_{event,1} associated with the first sub-block block may be the time t_{b} associated with the starting data offset s_{b} (e.g., t_{event,1}=t_{b}). Time t_{b} may be determined using the same interpolative process described above. For example, time t_{b} may be calculated using the formula:

$${t}_{b} = {t}_{1} + \frac{( {t}_{2} - {t}_{1} ) \cdot ( {s}_{b} - {s}_{1} )}{{s}_{2} - {s}_{1}}$$

The second event time t_{event,2} associated with the second sub-block may be the time at which the earliest byte of the second sub-block was written to log file 137. For implementations in which the block of non-processed bytes is divided into sub-blocks delimited by the one or more observed size values, the time at which the earliest byte of the second sub-block was written to log file 137 may coincide with observation time t₂ (e.g., t_{event,2}=t₂). The weighted average for the event time tₑᵥₑₙₜ may be expressed as:

$${t}_{event} = \frac{{t}_{event , 1} \cdot ( {s}_{2} - {s}_{b} ) + {t}_{event , 2} \cdot ( {s}_{e} - {s}_{2} )}{{s}_{e} - {s}_{b}}$$

where the weights applied to the terms t_{event,1} and t_{event,2} are the respective proportions of bytes within the first and second sub-blocks to the total number of bytes in the non-processed block, and where tₑᵥₑₙₜ is a weighted average event time for the events in the block of non-processed bytes.

This result may be generalized to the situation in which the block of non-processed bytes spans three or more discrete portions of the log file using the equation:

$${t}_{event} = \frac{{t}_{event , 1} \cdot ( {s}_{2} - {s}_{b} ) + {\sum }_{x = 2}^{n - 1} {t}_{event , x} \cdot ( {s}_{x + 1} - {s}_{x} ) + {t}_{event , n} \cdot ( {s}_{e} - {s}_{b} )}{{s}_{e} - {s}_{b}}$$

where t_{event,1} is the interpolated time value t_{b} (e.g., t_{event,1}=t_{b}) and where t_{event,2}-t_{event,n} coincide with observation times t₂-tₙ, respectively (e.g., t_{event,i}=tᵢ for 2≤i≤n).

Still referring to FIG. 11, process 200 is shown to include determining a processing delay associated with the event by computing a difference between the event time and a current time (step 208). Once tₑᵥₑₙₜ is determined, the event processing delay t_{delay} may readily be determined by subtracting the event time tₑᵥₑₙₜ from the current time t_{now} (e.g., t^{delay}=t_{now}−t^{event}).

In some implementations, process 200 includes determining an event processing delay for one or more additional non-processed events (step 210) and computing an average event processing delay by averaging the event processing delays for the event and the one or more additional non-processed events (step 212). The event processing delay for the one or more additional events may be determined by repeating some or all of steps 202-208. The average event processing delay t_{delay,avg} may be computed using the formula:

$${t}_{delay , avg} = {\sum }_{i = 1}^{z} \frac{{t}_{delay , i}}{z}$$

where z is the total number of non-processed blocks or sub-blocks in processing pipeline 121, t_{delay,i} is the event processing delay associated with the ith non-processed block or sub-block, and 1≤i≤z.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A method for determining an event processing delay, the method comprising:
receiving, at a computer system, a log file including one or more non-processed events, each event of the one or more non-processed events having a data offset identifying a location of the event in the log file;
identifying, by the computer system, a plurality of statistical data points for the log file, wherein each of the statistical data points includes a time value and a size value, the size value indicating a file size of the log file at a time corresponding to the time value, wherein identifying each statistical data point includes observing, by the computer system, a data size of the log file at a particular time and recording the data size at the particular time in association with a time value for the particular time;
determining, by the computer system, an event time for an event of the one or more non-processed events, wherein determining the event time includes:
(i) identifying the data offset for the event;
(ii) comparing the data offset for the event to size values of at least a portion of the plurality of statistical data points;
(iii) identifying a first statistical data point of the plurality of statistical data points having a size value that is lesser than the data offset for the event;
(iv) identifying a second statistical data point of the plurality of statistical data points having a size value that is greater than the data offset for the event;
(v) interpolating a new data point between the first statistical data point and the second statistical data point, the new data point having an interpolated time value, wherein the interpolated time value is interpolated by comparing the data offset for the event to at least one of the size value of the first statistical data point and the size value of the second statistical data point; and
determining, by the computer system, a processing delay associated with the event, wherein the processing delay is determined by computing a difference between the event time and a current time;
using the determined processing delay to identify a system health status of the computer system.

2. The method of claim 1, further comprising:
determining an event processing delay for one or more additional non-processed events;
computing an average event processing delay by averaging the event processing delays for the event and the one or more additional non-processed events; and
reporting the average event processing delay.

3. The method of claim 1, wherein the data offset for the event is a data offset for a block of non-processed bytes in the log file, the block of non-processed bytes including one or more of the non-processed events,
wherein the data offset for the block of non-processed bytes is the data offset associated with each of the one or more non-processed events in the block of non-processed bytes.

4. The method of claim 1, further comprising:
identifying a block of non-processed bytes in the log file, the block of non-processed bytes having a starting data offset and an ending data offset, wherein the block of non-processed bytes includes one or more of the non-processed events;
identifying multiple discrete portions of the log file, wherein the multiple discrete portions are delimited by the plurality of statistical data points; and
determining whether the block of non-processed bytes spans multiple discrete portions of the log file, wherein the block of non-processed bytes spans multiple discrete portions of the log file if the size value of one or more of the statistical data points is between the starting data offset and the ending data offset,
wherein determining the event time for an event in a block of non-processed bytes which spans multiple discrete portions of the log file is performed using a first interpolation technique and determining the event time for an event in a block of non-processed bytes which does not span multiple discrete portions of the log file is performed using a second interpolation technique, the first interpolation technique being distinct from the second interpolation technique.

5. The method of claim 1, further comprising:
prior to determining the event time for the event, determining whether the event is in a block of non-processed bytes which spans multiple discrete portions of the log file or whether the event is in a block of non-processed bytes which does not span multiple discrete portions of the log file,
wherein if the event is in a block of non-processed bytes which does not span multiple discrete portions of the log file, determining the event time for the event includes identifying the interpolated time value as the event time.

6. The method of claim 1, further comprising:
prior to determining the event time for the event, determining whether the event is in a block of non-processed bytes which spans multiple discrete portions of the log file or whether the event is in a block of non-processed bytes which does not span multiple discrete portions of the log file,
wherein if the event is in a block of non-processed bytes which spans multiple discrete portions of the log file, determining the event time for the event includes:
dividing the block of non-processed bytes into multiple sub-blocks;
determining a sub-event time for each of the multiple sub-blocks; and
determining the event time by computing a weighted average of the multiple sub-event times.

7. The method of claim 6, wherein dividing the block of non-processed bytes into multiple sub-blocks comprises:
identifying one or more of the plurality of statistical data points having a size value between a starting data offset of the block of non-processed bytes and an ending data offset of the block of non-processed bytes;
using the starting data offset of the block of non-processed bytes as a data offset for a first sub-block of the multiple sub-blocks; and
using the one or more size values of the identified statistical data points as data offsets for one or more additional sub-blocks of the multiple sub-blocks.

8. The method of claim 6, wherein determining a sub-event time for each of the multiple sub-blocks comprises:
identifying one or more of the plurality of statistical data points having a size value between a starting data offset of the block of non-processed bytes and an ending data offset of the block of non-processed bytes;
using the interpolated time value as the sub-event time for a first of the multiple sub-blocks, wherein the starting data offset for the block of non-processed bytes is the data offset associated with the event used for interpolating the interpolated time value; and
using the one or more time values of the identified statistical data points as the sub-event times for one or more additional sub-blocks of the multiple sub-blocks.

9. The method of claim 6, wherein computing the weighted average of the multiple sub-event times comprises:
identifying a data size for each of the multiple sub-blocks;
determining a weight for each of the multiple sub-blocks, wherein the weight for a sub-block is determined by dividing the data size of the sub-block by a data size of the block of non-processed bytes; and
computing the weighted average by multiplying, for each of the multiple sub-blocks, the weight for the sub-block by the sub-event time for the sub block and summing the resultant products.

10. The method of claim 1,
wherein determining the event time further comprises:
identifying a data offset proportion by dividing a first difference between the data offset for the event and the size value of the first statistical data point by a second difference between the size value of the second statistical data point and the size value of the first statistical data point;
identifying a time value proportion by multiplying the data offset proportion by a difference between the time value of the second statistical data point and the time value of the first statistical data point; and
determining the event time by adding the time value proportion to the time value of the first statistical data point.

11. The method of claim 1, wherein the event time is determined without reading event data from the log file.

12. The method of claim 1, wherein the log file does not include timestamps associated with the one or more non-processed events.

13. The method of claim 1, further comprising:
collecting the plurality of statistical data points for the log file, wherein collecting the plurality of statistical data points includes:
observing a first file size of the log file at a first time;
recording a first statistical data point, wherein the first file size is the size value of the first statistical data point and the first time is the time value of the first statistical data point; and
repeating the observing and recording steps until a plurality of statistical data points are collected.

14. The method of claim 13, further comprising:
controlling an accuracy of the event time determination by adjusting a rate at which the plurality of statistical data points are collected.

15. The method of claim 1, further comprising:
selecting one or more of the plurality of statistical data points for removal from the plurality of statistical data points, wherein selecting one or more of the plurality of statistical data points for removal includes:
identifying the time values associated with the plurality of statistical data points;
determining a subset of the plurality of statistical data points for which a uniformity of distribution of the time values associated with the plurality of statistical data points in the subset is maximized; and
selecting for removal one or more of the plurality of statistical data points not in the subset.

16. A computer system for determining event processing delays, the computer system comprising:
a communications interface configured to receive a log file including one or more non-processed events, wherein each event of the one or more non-processed events is associated with a data offset identifying a location of the event in the log file; and
a processing circuit configured to identify a plurality of statistical data points for the log file, wherein each of the statistical data points includes a time value and a size value, the size value indicating a file size of the log file at a time corresponding to the time value, wherein identifying each statistical data point includes observing, by the computer system, a data size of the log file at a particular time and recording the data size at the particular time in association with a time value for the particular time,
wherein the processing circuit is configured to determine an event time for an event of the one or more non-processed events, wherein determining the event time includes
(i) identifying the data offset for the event;
(ii) comparing the data offset for the event to size values of at least a portion of the plurality of statistical data points;
(iii) identifying a first statistical data point of the plurality of statistical data points having a size value that is lesser than the data offset for the event;
(iv) identifying a second statistical data point of the plurality of statistical data points having a size value that is greater than the data offset for the event;
(v) interpolating a new data point between the first statistical data point and the second statistical data point, the new data point having an interpolated time value, wherein the interpolated time value is interpolated by comparing the data offset for the event to at least one of the size value of the first statistical data point and the size value of the second statistical data point,
wherein the processing circuit is configured to determine a processing delay associated with the event, wherein the processing delay is determined by computing a difference between the event time and a current time;
wherein the processing circuit is configured to use the determined processing delay to identify a system health status of the computer system.

17. The system of claim 16, wherein the processing circuit is further configured to:
determine an event processing delay for one or more additional non-processed events;
compute an average event processing delay by averaging the event processing delays for the event and the one or more additional non-processed events; and
report the average event processing delay.

18. The system of claim 16, wherein the data offset for the event is a data offset for a block of non-processed bytes in the log file, the block of non-processed bytes including one or more of the non-processed events,
wherein the data offset for the block of non-processed bytes is the data offset associated with each of the one or more non-processed events in the block of non-processed bytes.

19. The system of claim 16, wherein the processing circuit is further configured to:
identify a block of non-processed bytes in the log file, the block of non-processed bytes having a starting data offset and an ending data offset, wherein the block of non-processed bytes includes one or more of the non-processed events;
identify multiple discrete portions of the log file, wherein the multiple discrete portions are delimited by the plurality of statistical data points; and
determine whether the block of non-processed bytes spans multiple discrete portions of the log file, wherein the block of non-processed bytes spans multiple discrete portions of the log file if the size value of one or more of the statistical data points is between the starting data offset and the ending data offset,
wherein determining the event time for an event in a block of non-processed bytes which spans multiple discrete portions of the log file is performed using a first interpolation technique and determining the event time for an event in a block of non-processed bytes which does not span multiple discrete portions of the log file is performed using a second interpolation technique, the first interpolation technique being distinct from the second interpolation technique.

20. The system of claim 16, wherein the processing circuit is further configured to:
prior to determining the event time for the event, determine whether the event is in a block of non-processed bytes which spans multiple discrete portions of the log file or whether the event is in a block of non-processed bytes which does not span multiple discrete portions of the log file,
wherein if the event is in a block of non-processed bytes which does not span multiple discrete portions of the log file, determining the event time for the event includes identifying the interpolated time value as the event time.

21. The system of claim 16, wherein the processing circuit is further configured to:
prior to determining the event time for the event, determine whether the event is in a block of non-processed bytes which spans multiple discrete portions of the log file or whether the event is in a block of non-processed bytes which does not span multiple discrete portions of the log file,
wherein if the event is in a block of non-processed bytes which spans multiple discrete portions of the log file, determining the event time for the event includes:
dividing the block of non-processed bytes into multiple sub-blocks;
determining a sub-event time for each of the multiple sub-blocks; and
determining the event time by computing a weighted average of the multiple sub-event times.

22. The system of claim 21, wherein dividing the block of non-processed bytes into multiple sub-blocks comprises:
identifying one or more of the plurality of statistical data points having a size value between a starting data offset of the block of non-processed bytes and an ending data offset of the block of non-processed bytes;
using the starting data offset of the block of non-processed bytes as a data offset for a first sub-block of the multiple sub-blocks; and
using the one or more size values of the identified statistical data points as data offsets for one or more additional sub-blocks of the multiple sub-blocks.

23. The system of claim 21, wherein determining a sub-event time for each of the multiple sub-blocks comprises:
identifying one or more of the plurality of statistical data points having a size value between a starting data offset of the block of non-processed bytes and an ending data offset of the block of non-processed bytes;
using the interpolated time value as the sub-event time for a first of the multiple sub-blocks, wherein the starting data offset for the block of non-processed bytes is the data offset associated with the event used for interpolating the interpolated time value; and
using the one or more time values of the identified statistical data points as the sub-event times for one or more additional sub-blocks of the multiple sub-blocks.

24. The system of claim 21, wherein computing the weighted average of the multiple sub-event times comprises:
identifying a data size for each of the multiple sub-blocks;
determining a weight for each of the multiple sub-blocks, wherein the weight for a sub-block is determined by dividing the data size of the sub-block by a data size of the block of non-processed bytes; and
computing the weighted average by multiplying, for each of the multiple sub-blocks, the weight for the sub-block by the sub-event time for the sub block and summing the resultant products.

25. The system of claim 16, wherein determining the event time further comprises:
identifying a data offset proportion by dividing a first difference between the data offset for the event and the size value of the first statistical data point by a second difference between the size value of the second statistical data point and the size value of the first statistical data point;
identifying a time value proportion by multiplying the data offset proportion by a difference between the time value of the second statistical data point and the time value of the first statistical data point; and
determining the event time by adding the time value proportion to the time value of the first statistical data point.

26. The system of claim 16, wherein the processing circuit is configured to determine the event time without reading event data from the log file.

27. The system of claim 16, wherein the log file does not include timestamps associated with the one or more non-processed events.

28. The system of claim 16, wherein the processing circuit is further configured to:
collect the plurality of statistical data points for the log file, wherein collecting the plurality of statistical data points includes:
observing a first file size of the log file at a first time;
recording a first statistical data point, wherein the first file size is the size value of the first statistical data point and the first time is the time value of the first statistical data point; and
repeating the observing and recording steps until a plurality of statistical data points are collected.

29. The system of claim 28, wherein the processing circuit is further configured to:
control an accuracy of the event time determination by adjusting a rate at which the plurality of statistical data points are collected.
